(19) United States
(12) Patent Application Publication
(10) Pub. No.: US 2017/0305391 A1
(43) Pub. Date: Oct. 26, 2017

(54) CONNECTOR AND CONNECTION DEVICE FOR ASSEMBLING A MOTOR VEHICLE ACTUATING ARM WITH A WIPER BLADE

(71) Applicant: Valeo Systèmes d'Essuyage, Le Mesnil Saint Denis (FR)

(72) Inventors: Olivier Jomard, Le Mesnil Saint Denis Cedex (FR); Vincent Gaucher, Le Mesnil Saint Denis Cedex (FR)

(73) Assignee: Valeo Systèmes d'Essuyage, Le Mesnil Saint Denis (FR)

(21) Appl. No.: 15/491,049

(22) Filed: Apr. 19, 2017

(30) Foreign Application Priority Data
Apr. 20, 2016 (FR) 1653477

(51) Int. Cl. B60S 1/40; B60S 1/38

(52) U.S. Cl. CPC B60S 1/4077; B60S 1/38

(57) ABSTRACT

The invention relates to a connector (6) for assembling a motor vehicle actuating arm with a wiper blade (2), said connector comprising;
a transverse pin (8) intended to be linked to an actuating arm, said transverse pin (8) being located transversely between a first and a second lateral wall (10a, 10b) of the connector (6),
a lateral connection interface (11) supported by one of the two lateral walls (10a, 10b),
characterized in that the connector (6) moreover comprises at least one latching tab (19a, 19b) projecting from the lateral wall (10b) supporting the lateral connection interface (11), said latching tab (19a, 19b) being configured to cooperate with a lateral edge (20) of the connection platform (7).

The present invention also relates to a connection device (3) and a wiper device (1).

The present invention relates to a connector and a connection device for assembling a motor vehicle actuating arm with a wiper blade. The invention also relates to a wiper device comprising a wiper blade and a connection device.

The special feature of flat blades is that they no longer have a rudder structure. They comprise a non-rigid wiper strip and a flexible structure directly integrated in said strip.

These blades comprise connection means which allow them, to be connected to actuating arms in an appropriate manner. It should be remembered in this respect that there are all kinds of actuating arms, such as hooked arms, arms with a lateral pivot axis, arms with longitudinal clipping, etc.

These connection means comprise, on the one hand, a connection platform assembled with the wiper blade and, on the other hand, a link connector for linking to the actuating arm, intended to be assembled and locked on the connection platform. Consequently, the link connector comprises two types of connection means, namely means allowing the connection of the actuating arm on the connector, either directly or indirectly by means of an adapter part, and means of assembling and locking the connector on the connection platform.

Moreover, there are currently two types of connectors for joining a drive arm to the wiper blade; either a side-lock type link connector or a top-lock type link connector.

A side-lock connector is a connector comprising connection means offset on the side to join the drive arm to the connector. In this case, however, the locking of the offset connection means may exhibit insufficient stability allowing an unexpected displacement of the connector in respect of the platform.

One of the objects of the present invention is to propose a side-lock connector, the offset connection means whereof can be locked in the platform with greater stability.

To this end, the object of the invention is a connector for assembling a motor vehicle actuating arm with a wiper blade, said connector comprising:

a transverse pin intended to be linked to an actuating arm, said transverse pin being located transversely between a first and a second lateral wall of the connector,

a lateral connection interface supported by one of the two lateral walls, said interface comprising:
a plate projecting in a direction substantially perpendicular to the lateral wall of the connector,
at least one connection element supported by the plate and configured to cooperate with a connection platform assembled with the wiper blade to fix the connector in said platform in a reversible manner,

characterized in that the connector moreover comprises at least one latching tab projecting from the lateral wall supporting the lateral connection interface, said latching tab being configured to cooperate with a lateral edge of the connection platform.

The latching tab allows the relative transverse movement between the connector and the connection platform forming a holding point of the connector with the additional platform at the interface to be limited.

According to one or several characteristics of the connector, taken alone or in combination,

the connector comprises two latching tabs arranged on either side of the lateral connection interface, on the same side of the connector,

a first latching tab designed to cooperate with a lateral edge situated on a narrow side of the connection platform extends further transversely than a second latching tab intended to cooperate with the lateral edge situated on a wider side of the connection platform,

the connector comprises at least one lateral rib supported by the lateral wail supporting the lateral connection interface, the lateral rib being intended to be interposed between the connector and the connection platform,

the lateral rib extends in a direction perpendicular to a face of the plate,

the lateral rib is arranged perpendicularly to a latching tab,

the connector comprises two lateral ribs parallel to one another, arranged under the latching tab,

the connector comprises at least one reinforcement linking the lateral wall supporting the lateral connection interface to an upper face of the plate opposite a lower face supporting the at least one connection element,

the connector comprises a plurality of reinforcements formed by plates parallel to one another and perpendicular to the upper face of the plate.

Another object of the invention is a connection device intended to assemble a motor vehicle actuating arm with a wiper blade, characterized in that it comprises a connector such as that described previously and a connection platform.

Another object of the invention is a wiper device characterized in that it comprises a wiper blade and a connection device as described previously.

The following description with regard to the attached drawings, provided by way of non-limiting examples, will clearly illustrate what the invention involves and how it can be realized.

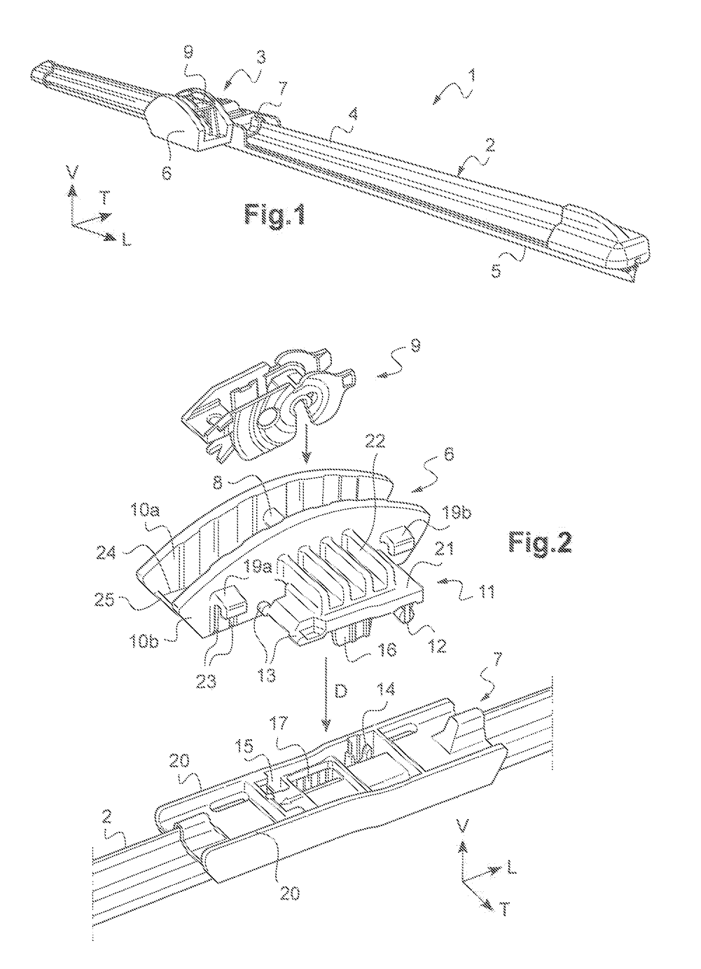

FIG. 1 is a perspective view of a wiper device.

FIG. 2 is an exploded perspective view of the connection device of the wiper device in FIG. 1.

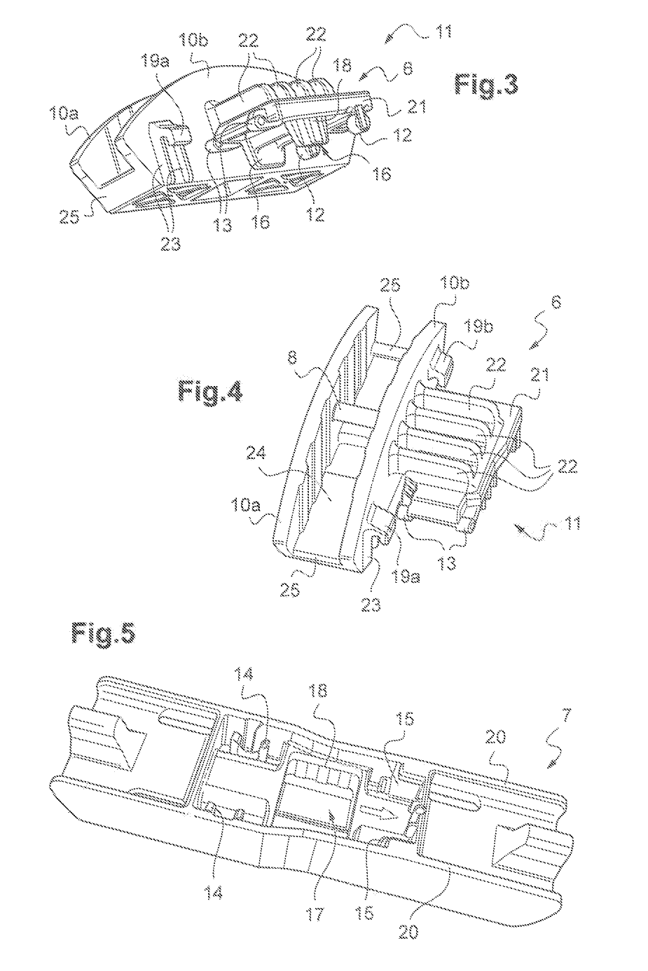

FIG. 3 is a perspective view of a connector of the connection device in FIG. 2.

FIG. 4 is another perspective view of the connector in FIG. 3.

FIG. 5 is a perspective view of a connection platform of the connection device in FIG. 2.

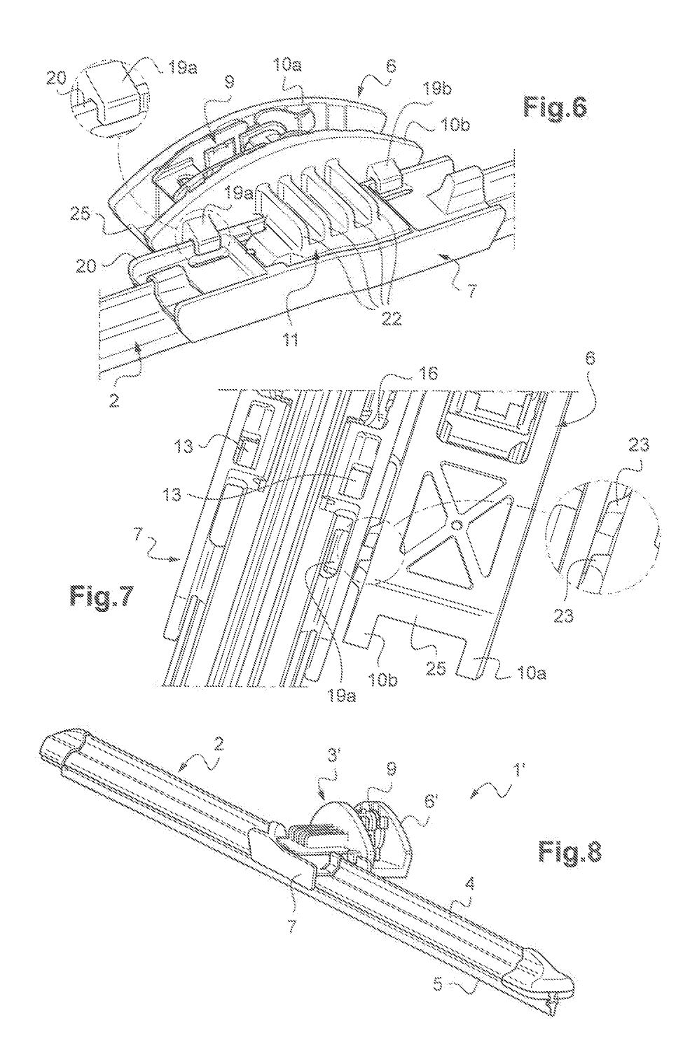

FIG. 6 shows a perspective view of the connection device in FIG. 2 in the assembled state, with an enlarged view of a latching tab of the connector cooperating with a lateral edge of the connection platform.

FIG. 7 shows a bottom view of the components in FIG. 6.

FIG. 8 shows another exemplary wiper device.

In the description that follows, longitudinal, vertical and transverse directions indicated in FIG. 1 by the trihedron (L, V, T) fixed in respect of the wiper blade 2 will be adopted without limitation. The longitudinal direction L corresponds to the main direction of the wiper blade 2.

Identical or similar components will be referred to using the same reference numbers.

The following embodiments are exemplary. Although the description refers to one or more embodiments, this does not necessarily mean that each reference number relates to the same embodiment or that the characteristics only apply to a single embodiment. Simple characteristics of different embodiments may likewise be combined or interchanged to provide other embodiments.

FIGS. 1 and 2 show a wiper device 1 comprising a wiper blade 2 and a connection device 3 intended for assembling an actuating arm of a motorized wiper mechanism of a motor vehicle to the wiper blade 2.

The wiper blade 2 is a blade of the flat blade type with a longitudinal main orientation L. It comprises a spoiler 4, a wiper strip 5 and at least one spline.

The spoiler 4 and the wiper strip 5 are made of non-rigid material. They can be obtained by the moulding or extrusion of one or several materials.

The spline is, for example, formed from a body in a single piece comprising, for example, a planar metal strip which is particularly curved vertically, such that when the wiper blade 2 bears against the windscreen, the bearing forces exerted by the driving arm are distributed over the entire length of the wiper strip 5.

The connection device 3 comprises a connector 6 and a connection platform 7 intended to be assembled with the wiper blade 2.

As can be seen in FIGS. 3 and 4, the connector 6 comprises a transverse pin 8 capable of being joined, directly or by means of an adapter 9, to an actuating arm, as well as a lateral connection interface 11.

For each type of attachment of the actuating arm, such as hooked arms, arms with a lateral pivot axis, longitudinal clipping/snap-fitting arms, etc., for example, there will be a specific adapter 9, but each of these adapters 9 are adapted to the same connector 6 by a standard interface.

The transverse pin 8 is arranged transversely between a first lateral wall 10a and a second lateral wall 10b of the connector 6. The lateral walls 10a, 10b are joined to one another at their ends by a flat base 24, in such a manner as to form a housing with a U-shaped cross section.

The connector 6 may exhibit at least one transverse spline arranged between the lateral walls 10a, 10b to increase the stability of the sides, in particular to ensure the stability of the connector 6 during unmoulding.

For example, two transverse edges 25 link each end of the flat base 24 to the two lateral walls 10a, 10b.

The lateral connection interface 11 is supported by one of the two lateral walls 10a, 10b of the connector 6.

The interface 11 comprises a plate 21 projecting in a substantially perpendicular direction to the lateral wall 10b of the connector 6 and at least one connection element 12, 13.

The at least one connection element 12, 13 is configured to cooperate with complementary connection elements 14, 15 supported by the connection platform 7 assembled with the wiper blade 2 to fix the connector 6 in said platform 7 in a reversible manner.

The connection elements 12, 13 are supported by a lower face of the plate 21, in other words by the face facing the platform 7 in the assembled state. The lateral connection interface 11 therefore allows the connection elements 12, 13 to be offset on one side of the wiper blade 2, known as a side lock.

The connector 6 may comprise at least one reinforcement 22 joining the lateral face 10b supporting the lateral connection interface 11 to the upper face of the plate 21 opposite that supporting the connection elements 12, 13.

The connector 6 comprises, for example, a plurality of reinforcements 22 formed by plates which are parallel to one another and perpendicular to the upper face of the plate 21.

The connection elements 12, 13 of the interface 11 comprise, for example, at least one projection 12, for example two, one facing the other, as well as at least one cylindrical stud 13, for example two, one facing the other, the projections 12 and the cylindrical studs 13 forming a rectangle, for example, substantially in the corners of the plate 21. The projections 12 may be realized by cylinders, the axis whereof extends in the transverse direction, like the axes of the cylindrical studs 13.

It can be seen more clearly from FIG. 5 that the complementary connection elements 14, 15 supported by the platform 7 comprise, for example, at least one fork 14 configured to cooperate by elastic deformation with a respective projection 12 of the interface 11 and at least one recess 15 configured to receive and hold a respective cylindrical stud 13.

The lower face of the plate 21 of the lateral connection interface 11 may support at least one guide flange 16 adapted to be inserted into an opening 17 made in the connection platform 7. For example, the connection interface 11 comprises two guide flanges 16 parallel with one another, each flange 16 being aligned, for example, with a cylindrical stud 13 and a projection 12 in the longitudinal direction, the flanges 16 being capable of being inserted into the matching opening 17 with a square or rectangular cross section against the lateral internal faces of the opening 17.

In order to improve the guidance, it may be provided that the internal lateral faces of the opening 17 and external lateral faces of the guide flanges 16 in contact with the assembly exhibit matching guiding ribs 18 oriented in the assembly direction D of the projections 12 in the forks 14, in other words in the vertical direction of the figures.

The connector 6 moreover comprises at least one latching tab 19a, 19b projecting from the lateral wall 10b of the connector 6 supporting the interlace 11, the latching tab 19a, 19b being configured to cooperate with a lateral edge 20 of the connection platform 7.

The latching tab 19a, 19b is curved in the direction of the connection platform 7 and is arranged substantially at the height of the plate 21 of the lateral connection interface 11 to nook onto the lateral edge 20 of the platform 7 in the assembled state, when the connection elements 12, 13 and the complementary connection elements 14, 15 are engaged with one another (see FIG. 6).

The latching lug 19a, 19b allows the relative transverse displacement between the connector 6 and the connection platform 7 forming a holding point of the connector 6 to the platform 7 in addition to the interface 11, to be limited.

The connector 6 comprises, for example, two latching tabs 19a, 19b arranged on either side of the lateral connection interface 11, on the same side of the connector 6, in other words projecting from the lateral wall 10b of the corrector 6 supporting the interface 11. The two latching tabs 19a, 19b may be substantially aligned in the longitudinal direction.

Two latching tables 19a, 19b allow the stability of the assembly to be further improved.

The connection platform 7 extends in a main longitudinal direction, for example, exhibiting a substantially central transverse narrowing. One side of the narrowing, that in which the recesses 15 are made, may therefore be narrower than the other side, the one supporting the forks 14 (FIG. 5). It is therefore possible to envisage, on the one hand, that a first latching tab 19a designed to cooperate with the lateral edge 20 of the narrow side of the platform 7 extends further in the transverse direction than a second latching tab 19b intended to cooperate with the lateral edge 20 situated on the wider side.

On the other hand, the connector 6 may comprise at least one lateral rib 23 supported by the lateral wall 10b. The lateral rib 23 extends in the assembly direction D, for example, in other words perpendicularly to the upper or lower face of the plate 21, in other words in the vertical direction of the figures. The lateral rib 23 is thereby interposed between the connector 6 and the connection platform 7 in the assembled state.

The lateral rib 23 is, for example, arranged perpendicularly to the first latching tab 19a extending further in the transverse direction.

It may be envisaged, for example, that the connector 6 comprises two lateral ribs 23 parallel to one another, arranged under the first latching tab 19a.

As can be seen more clearly from FIG. 7, these lateral ribs 23 allow the gap between the lateral connection interface 11 and the lateral edge 20 of the narrow side of the platform 7 to be filled.

The connector 6 is, for example, realized in a single piece of plastic material.

During assembly, two successive movements are carried out, namely a first movement to insert the cylindrical studs 13 into the recesses 15 in the platform 7 under the upper abutments of the recesses 15, then a second pivoting movement of she connector 6 about the cylindrical studs 13, to engage the projections 12 with the forks 14 by a clipping action.

The flanges 16 are inserted into the opening 17, against its internal lateral faces, the guide ribs 18 of the opening 17 and the guiding flanges 16 cooperating to orient the assembly in the assembly direction D.

The latching tabs 19a, 19b hook onto a lateral edge 20 of the platform 7, limiting the relative transverse displacement between the connector 6 and the connection platform 7.

The lateral ribs 23 fill the gap between the lateral connection interface 11 and the lateral edge 20 on the narrow side of the platform 7.

The connector 6 is then assembled and locked in a stable manner in the connection platform 7.

Although the FIGS. 1 to 7 illustrate a side-lock connector 6 with a lateral connection interface 11 supported by a lateral wall 10b intended to position the wiper blade 2 behind the arm, in other words interposed between the actuating arm and the windscreen of the motor vehicle, it is also possible that the lateral connection interface 11, and therefore the latching tabs 19a, 19b and the guiding ribs 23, are supported by the other lateral wall 10a, as shown in FIG. 8, then positioning the wiper blade 2 in front of the arm, the actuating arm being interposed between the wiper blade 2 and the windscreen of the vehicle. The latching tabs 19a, 19b and the guiding ribs 23 then cooperate with the lateral sage 20 of the connection platform 7 situated on the opposite side.

1. A connector for assembling a motor vehicle actuating arm with a wiper blade, said connector comprising:
a transverse pin configured to be linked to an actuating arm, said transverse pin being located transversely between a first and a second lateral wall of the connector;
a lateral connection interface supported by one of the two lateral walls, said interface comprising:
a plate projecting in a direction substantially perpendicular to the lateral wall of the connector, and
at least one connection element supported by the plate and configured to cooperate with a connection platform assembled with the wiper blade to fix the connector in said platform in a reversible manner; and
at least one latching tab Projecting from the lateral wall supporting the lateral connection interface, said latching tab being configured to cooperate with a lateral edge of the connection platform.

2. The connector according to claim 1, further comprising two latching tabs arranged on either side of the lateral connection interface on the same side of the connector.

3. The connector according to claim 1, wherein a first latching tab configured to cooperate with a lateral edge situated on a narrow side of the connection platform extends further transversely than a second latching tab intended to cooperate with the lateral edge situated on a wider side of the connection platform.

4. The connector according to claim 1, further comprising at least one lateral rib supported by the lateral wall supporting the lateral connection interface, the lateral rib being interposed between the connector and the connection platform.

5. The connector according to claim 1, wherein the lateral rib extends in a direction perpendicular to a face of the plate.

6. The connector according to claim 4, wherein the lateral rib is arranged perpendicularly to a latching tab.

7. The connector according to claim 6, further comprising two lateral ribs parallel to one another, arranged under the latching tab.

8. The connector according to claim 1, further comprising at least one reinforcement linking the lateral wall supporting the lateral connection interface to an upper face of the plate opposite a lower face supporting the at least one connection element.

9. The connector according to claim 8, further comprising a plurality of reinforcements formed by plates parallel to one another and perpendicular to the upper face of the plate.

10. A connection device for assembling a motor vehicle actuating arm with a wiper blade, the device comprising: a connector according to claim 1; and a connection platform.

11. A wiper device comprising a wiper blade; and a connection device according to claim 10.
